(19) United States
(12) Patent Application Publication
(10) Pub. No.: US 2024/0233043 A1
(43) Pub. Date: Jul. 11, 2024

(54) Method for generating a romantic profile and identifying education resources tailored to improve deficiencies therein

(71) Applicant: Paul Dobransky, Aurora, CO (US)

(72) Inventor: Paul Dobransky, Aurora, CO (US)

(21) Appl. No.: 18/610,170

(22) Filed: Mar. 19, 2024

Related U.S. Application Data
(63) Continuation-in-part of application No. 17/185,598, filed on Feb. 25, 2021, now abandoned.

(51) Int. Cl. G06Q 50/00; H04L 67/306

(52) U.S. Cl. CPC G06Q 50/01; H04L 67/306

(57) ABSTRACT

A method and system for creating a romantic profile that is useful for filtering candidates for romantic compatibility and providing the user educational material that selected based on deficiencies in the romantic profile.

This application is a continuation-in-part that claims the benefit of nonprovisional application Ser. No. 17/185,598. Furthermore, application Ser. No. 17/185,598 is hereby incorporated by reference.

### FIELD OF THE INVENTION

The present invention relates generally to data processing, and it is specifically directed to a methods and system creating a romantic profile of a user that is useful for both: (a) filtering the candidate pool of other persons with whom a user could reasonably expect to have romantic compatibility with; and (b) providing the user educational material that is tailored to improve the user's romantic compatibility with more persons.

### BACKGROUND OF THE INVENTION

Conventional technology in the field of human courtship consists of research on various aspects of human courtship, but no overarching model links researched variables and principles into a single unified model to explain the processes of romance and the interconnection of persons. Doing such an integration leads to more comprehensive and thorough guidance for individuals looking to solve problems of love and relationships, regardless of complexity, and in a manner tailored to their specific challenges and psychological constitutions.

Moreover, while dating/matchmaking companies and algorithms exist, current technologies do not provide comprehensive or systematic way of advancing the romantic psychology education of users toward consistent, reliable improvement in romantic psychological skill or improved outcomes pertaining to personal or romantic goals (e.g. marriage, happy relationships, or the interest, loyalty, attraction or commitment to them, by the type of partner or specific kind of mate a user seek.) associated with the user.

Existing models of psychology in general and of human courtship in particular are limited in the scope of what they address in most robust fashion. As a result, educational portals, searches and databases do not address the specific needs of an individual user of online psychology resources in a way comprehensively targeted to their educational needs or personal problems. Further, the current technologies do not educate the user on science principles of psychology, courtship or romance through their sites. Further, the current technologies do not join education from the arts and humanities with that of science, to enhance symbolic learning or retention of that learning for the user. Further, the current technologies do not provide pictorial and algorithmic methods of romantic dynamics that may accelerate the speed and depth of learning psychology and human courtship by the user, especially for those who learn most effectively through the visual presentation of educational material. Furthermore, the current technologies do not provide standardized measures of the overall or specific qualities, skills, knowledge or relationship behaviors of other users with which one may be matched, or with whom communication is brokered. Moreover, the current technologies do not assist the user to select potential dates or mates based on a standardized quantifiable set of scores and measures of their overall knowledge and skill at human courtship and relationship psychology, that may result in more lasting compatibility romantically, or at least the ability to rationally solve romantic conflicts and other problems of relationship psychology in their own lives.

In addition, current and past dating/matchmaking platforms focused more on connecting users with each other, facilitating communication between users, and selecting other user-members for consideration for dating or courtship, but did not educate users on the scientific principles of psychology, courtship, or romance through their platforms, nor did they couple educational materials with those principles to enhance symbolic learning and learning retention on the part of the user. Other than making word associations of user-inputted words in describing oneself via a profile, there was also no standardized measures of the qualities, skills, knowledge, or relationship behaviors of other users with which one may be successfully matched, or with whom communication is brokered.

Therefore, there is a need for improved methods and systems for identifying specific root impediments to the development of romantic relationships and for directing users to available educational materials that were designed to remove those specific impediments to the extent reasonably possible. The present invention for a method for generating a romantic profile of a user and identifying education resources tailored to improve deficiencies therein substantially fulfills that need.

### SUMMARY OF THE INVENTION

In a preferred embodiment, the present method is a computer and telecommunications network implemented method for creating a romantic profile that is useful in filtering plausible candidates for successful romantic relationships and for identifying self-improvement content that is useful in improving one's romantic relationship compatibility. It is anticipated that a telecommunications network will be used to enable remotely located users to interact with a profile creating service provider's computer-driven platform (i.e., a processor(s) and database(es)). It is further anticipated the many of the interactions will be Socratic questions and responses designed to elicit, from the user, a variety of information about his/her personal circumstances, personal preferences, or self-conceptions that broadly relate to sexuality, emotion, and intellect.

These interactions in which the provider platform is submitting questions to the user concerning sexual, emotional, and intellectual matters, and the user is submitting responses enable to the platform to general a plurality of indicators of user traits pertaining to sexuality, emotion, and intellect. For example, such indicators may concern the interacting user's exhibition and/or recognition of masculine or feminine traits, mindfulness; constructiveness, and recognition of personal boundaries to name a few. The indicators shall range from low to high, where a higher indicator correlates to at least a threshold level of compatibility, relative to that subject matter of the indicator, that is understood to likely be necessary to facilitate a successful romantic relationship with the average person.

Taken altogether, the user-platform interactions function as standardized testing of the romantic knowledge and perceptions of the interacting user, and the plurality of sexual, emotional, and intellectual indicators that they are translated into collectively form a romantic profile of the user. This romantic profile functions, in the area of romantic relationship compatibility, analogous to how a credit score functions in the area of financial transaction worthiness. Furthermore, such a romantic profile correlates to predictable degrees of sexual, emotional, and intellectual compatibility with other platform-generated romantic profiles.

This heretofore unavailable feature enables a user to select potential dates or mates based on a standardized quantifiable set of scores and measures of their overall knowledge of and skill at human courtship and relationship psychology, which may result in more lasting compatibility romantically, or at least the ability to rationally solve romantic conflicts and other problems of relationship psychology in their own lives. The present invention is also superior to prior art matchmaking methods by virtue of the fact that it brings to the attention of the user a collection of printed materials on love, romance, and human courtship—and does so based on the platform's predetermined assessment of which such materials are most capable of improving the indicator(s) that are lowest within that particular user's romantic profile.

What is claimed is:

1. A method for generating a romantic profile of a user using a computing device and a telecommunications network, the method comprising:
receiving, via the network, user-provided information regarding sexual, emotional, and intellectual matters, wherein this information concerns at least one of the user's:
personal circumstances, personal preferences, or self-conceptions;
generating, at the computing device, indicators for sexual, emotional, and intellectual matters based on the user-provided information; and
generating a romantic profile of the user based on those sexual, emotional, and intellectual indicators, wherein the user's romantic profile correlates to predictable degrees of sexual, emotional, and intellectual compatibility with another person based upon the other person's similarly generated romantic profile.

2. The method of claim 1, wherein said romantic profile indicators each range from low to high, wherein higher such indicators for sexual, emotional, and intellectual matters correlate to reasonable degrees of sexual, emotional, and intellectual compatibility, respectively, with predictably more other persons than do lower such indicators.

3. The method of claim 1, further comprising sharing, with the user, said generated romantic profile corresponding thereto.

4. The method of claim 1, further comprising sharing, with the user, at least one romantic profile of another person that correlates to said user having reasonable degrees of sexual, emotional, and intellectual compatibility with that other person.

5. The method of claim 1, wherein said sexual, emotional, and intellectual indicators concern at least one of said user's: exhibition of masculine or feminine traits; recognition of masculine or feminine traits; mindfulness; constructiveness; and recognition of personal boundaries.

6. A method for generating a romantic profile of a user and identifying education resources tailored to improve deficiencies therein using a computing device and a telecommunications network, the method comprising:
receiving, via the network, user-provided information regarding sexual, emotional, and intellectual matters, wherein this information concerns at least one of the user's:
personal circumstances, personal preferences, or self-conceptions;
generating, at the computing device, indicators for sexual, emotional, and intellectual matters based on the user-provided information;
generating a romantic profile of the user based on those sexual, emotional, and intellectual indicators, wherein the user's romantic profile correlates to predictable degrees of sexual, emotional, and intellectual compatibility with another person based upon the other person's similarly generated romantic profile; and
identifying educational material that is categorized based on its predetermined likelihood to modify a user's indicators for sexual, emotional, or intellectual matters upon being consumed by the user.

7. The method of claim 6, wherein said romantic profile indicators each range from low to high, wherein higher such indicators for sexual, emotional, and intellectual matters correlate to reasonable degrees of sexual, emotional, and intellectual compatibility, respectively, with predictably more other persons than do lower such indicators.

8. The method of claim 6, further comprising sharing, with the user, said generated romantic profile corresponding thereto.

9. The method of claim 6, further comprising sharing, with the user, at least one romantic profile of another person that correlates to said user having reasonable degrees of sexual, emotional, and intellectual compatibility with that other person.

10. The method of claim 6, wherein said sexual, emotional, and intellectual indicators concern at least one of said user's: exhibition of masculine or feminine traits; recognition of masculine or feminine traits; mindfulness; constructiveness; and recognition of personal boundaries.
